(19) United States
(12) Patent Application Publication
(10) Pub. No.: US 2011/0046754 A1
(43) Pub. Date: Feb. 24, 2011

(54) INDUSTRIAL HMI AUTOMATICALLY CUSTOMIZED BASED UPON INFERENCE

(75) Inventors: Clifton Harold Bromley, New Westminster (CA); Kevin George Gordon, Annacis Island Delta (CA)

Correspondence Address: ROCKWELL AUTOMATION;for Turocy & Watson LLP, 1201 SOUTH SECOND STREET, E-7F19, MILWAUKEE, WI, 53204, US

(73) Assignee: ROCKWELL SOFTWARE, INC., West Allis, WI (US)

(21) Appl. No.: 12/939,693

(22) Filed: Nov. 4, 2010

Related U.S. Application Data
(62) Division of application No. 10/671,110, filed on Sep. 25, 2003.

(51) Int. Cl. G05B 15/00

(52) U.S. Cl. 700/83

(57) ABSTRACT

The present invention generally relates to industrial automation, and in particular to systems and methods that facilitate rendering data in an industrial automation environment. Specifically, the invention facilitates rendering a browser-based Human Machine Interface (HMI) to at least one device. According to an aspect of the present invention, a device can send a session request to an HMI generator. A session request-receiving component can process the request, and the HMI generator can process data related to an industrial automation environment and render such data to a device in browser format.

### CROSS REFERENCE TO RELATED APPLICATIONS

This application is a Divisional of co-pending U.S. patent application Ser. No. 10/671,110, entitled “WEB-BASED HMI,” filed on Sep. 25, 2003, the entirety of which is incorporated herein by reference.

### TECHNICAL FIELD

The present invention relates generally to industrial control systems, and more particularly to a system and methodology to facilitate rendering of data in an industrial automation environment.

### BACKGROUND OF THE INVENTION

Industrial control systems have enabled modern factories to become partially or completely automated in many circumstances. These systems generally include a plurality of Input and Output (I/O) modules that interface at a device level to switches, contactors, relays and solenoids along with analog control to provide more complex functions such as Proportional, Integral and Derivative (PID) control. Communications have also been integrated within the systems, whereby many industrial controllers can communicate via network technologies such as Ethernet, ControlNet, DeviceNet, FOUNDATION Fieldbus, PROFIBUS or other network protocols and also communicate to higher level computing systems. Generally, industrial controllers utilize the aforementioned technologies along with other technology to control, cooperate and communicate across multiple and diverse applications.

Industrial controllers and associated control systems have increasingly become more sophisticated and complicated as control applications have been distributed across the plant floor and in many cases across geographical or physical boundaries. As an example, multiple controllers and/or other devices can communicate and cooperate to control one or more aspects of an overall manufacturing process via a network, whereas other devices can be remotely located, yet still contribute to the same process. In other words, control applications have become less centrally located on a singular control system having associated responsibilities for an entire operation. Thus, distribution of an overall control function and/or process frequently occurs across many control components, systems or devices.

An aspect of control processes and/or functions that is often difficult to orchestrate is human governance. Humans must be able to communicate with each other and with control systems in order to effectuate highly organized and efficient control of an automated industrial environment. In order for a system to be accurately monitored, system interfaces must be created and maintained. Several types of interfaces exist: for example, hardware interfaces are merely linkages consisting of wires, plugs, sockets, etc. Through such interfaces, hardware devices communicate with one another. Software interfaces are composed of languages and/or codes used by a system for application-to-application communication and for communication between an application and a given hardware device. All of the above-mentioned interfaces permit real-time communication between respective participants without any appreciable latent period. However, user interfaces, which permit communication between a user and an operating system, or between a plurality of users via one or more operating systems, are often inefficient due to processing required to permit human interpretation and response. A user interface can be, for example, a mouse, a keyboard, a stylus, a monitor, a screen menu, an audio signal, or any other suitable input or output device.

One type of user interface is a Human Machine Interface (HMI). HMIs have myriad applications and are a particularly germane tool with regard to industrial automation information rendering. Conventional HMI rendering systems utilize closed circuit information loops wherein, for example, an automated environment is monitored and/or controlled in situ.

Traditional HMI systems rely on having HMI software components installed on many, if not all, of the computers used in the monitoring/control operation. In distributed applications, particularly those that utilize significant numbers of HMI operator stations, there is significant cost associated with installing and configuring the various software components on each of the operator computers, as well as with the on-going maintenance of such software, e.g., altering the configuration of software components as changes are made to the process being monitored and/or controlled, installing and configuring new software and/or new versions of existing software (having new capabilities), etc. Furthermore, computers with significant capabilities, performance, and cost are required to run such software. Thus, there exists a need in the art for systems and methods directed toward a real-time, web-based HMI.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Web-based technologies can be used to solve problems associated with traitional HMIs. The basic premise of a web-based application is that all (or at least most) of the application-specific software is installed and runs on a relatively small number of server computers, while the client computers that are used to access the provided functionality need only have the standard operating system and a web browser installed on them. As both the operating system and the web browser are typically installed on the computer by the vendor, the purchaser needs to do very little (if any) configuration to make these computers functional. For web-based applications, which require no application-specific client-side software, this results in a so-called “zero-install client.” Installation and configuration of the application-specific software (in our case, the web-based HMI software)—both the initial installation/configuration and subsequent upgrades/reconfigurations—need only be done on the significantly smaller number of server computers. Furthermore, since the client computers run only a web browser (as opposed to the traditional large, complex, computationally intensive and “resource hungry” application-specific software), significantly lower-cost computing hardware can be used. All of these attributes combine to significantly reduce the so-called “total cost of ownership” of the system.

The present invention provides for systems and methods that facilitate web-based implementation of HMIs in an industrial automation environment. One aspect of the invention relates to a browser-based HMI, which provides for executing HMI in a browser environment, thus mitigating the need for significant portions of persistent code resident on a local computing device. Additionally, the invention is fully capable of making advantageous use of downloadable components, including but not limited to, Java applets, Active X controls, and/or other such browser plug-ins, etc. The invention further provides for a user to connect via a browser to a server and receive a HMI that provides for interacting within an industrial automation environment. This aspect of the invention advantageously permits a user to monitor and/or control an industrial environment from a remote location. Additionally, this aspect of the invention permits a user to configure and administrate a system centrally, (e.g., a user can perform administrative and configuration tasks once, and not at every HMI workstation connected to the system), thereby reducing hardware and maintenance costs.

The invention allows a user to employ any of a variety of web-capable devices to access an industrial automation space over the web. In order to ensure security, the invention contemplates a variety of protocols and tools (e.g., terminal server, security, authentication, encryption, VPNs etc.). A VPN is a secure private network that links remote sites and/or users via a public network (e.g., the Internet). VPNs mitigate costs associated with conventional “real-world” connections, such as leased lines via employing “virtual” connections between users via the Internet.

Yet another aspect of the invention provides for transmitting significant amounts of data from servers to clients in a continuous, asynchronous fashion. Furthermore, the present invention can send “unsolicited” data from servers to specific clients. Such aspects advantageously solve problems in the current state of Web technology, which is client-driven and synchronous in nature, typically utilizing “request-response protocols”. Currently, each interaction between a client and a server consists of a client request and a server response (e.g., data is requested by a client, a server acknowledges that the requested operation has been performed, indicates an error condition, etc.). The client, after sending the request, must await the server's response before proceeding with other operations. Furthermore, once an individual request-response transaction has been completed, the connection between the client and server is severed, and a new connection must be established for each new transaction. The present invention can utilize continuous streams of data that can be transmitted between servers and clients, and, furthermore, can employ asynchronous and/or server initiated transactions in addition to client initiated transactions in order to provide solutions to the short-comings of current web-based technologies.

To the accomplishment of the foregoing and related ends, certain illustrative aspects of the invention are described herein in connection with the following description and the annexed drawings. These aspects are indicative, however, of but a few of the various ways in which the principles of the invention can be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is an illustration of a system in accordance with an aspect of the present invention in which a HMI generator is operably coupled to a device via a web browser.

FIG. 2 is an illustration of a system in accordance with an aspect of the present invention in which a HMI generator is operably coupled to a plurality of devices via a web browser(s).

FIG. 3 is an illustration of a system in accordance with an aspect of the present invention in which a customization component is associated with a HMI generator.

FIG. 4 is an illustration of an aspect of the present invention in which an artificial intelligence component is associated with a HMI generator.

FIG. 5 is an illustration of a system in accordance with an aspect of the present invention in which a memory is associated with a HMI generator.

FIG. 6 is an illustration of a system in accordance with an aspect of the present invention in which communications between a HMI generator and a device are encrypted via an encryption component.

FIG. 7 is an illustration of a system in accordance with an aspect of the invention in which communications between a HMI generator and a device are encrypted via a virtual private network.

FIG. 8 is an illustration of a methodology in accordance with an aspect of the invention for rendering a HMI in browser format.

FIG. 9 is an illustration of a methodology in accordance with an aspect of the present invention wherein a user can customize a HMI for rendering in browser format.

FIG. 10 is an illustration of a methodology in accordance with an aspect of the present invention wherein various security measures can be employed.

FIG. 11 is an illustration of a methodology in accordance with an aspect of the invention wherein a virtual private network is employed encrypt data transmissions between a device and a HMI generator.

FIGS. 12 and 13 are illustrations of exemplary computing systems and/or environments in connection with facilitating employment of the subject invention.

### DETAILED DESCRIPTION OF THE INVENTION

The present invention will now be described with reference to the drawings, wherein like reference numerals are used to refer to like elements throughout. The present invention will be described with reference to systems and methods for generating a web-based HMI in real time. It should be understood that the description of these exemplary aspects are merely illustrative and that they should not be taken in a limiting sense.

The term “component” refers to a computer-related entity, either hardware, a combination of hardware and software, software, or software in execution. For example, a component can be a process running on a processor, a processor, an object, an executable, a thread of execution, a program and a computer. By way of illustration, both an application running on a server and the server can be components. A component can reside in one physical location (e.g., in one computer) and/or can be distributed between two or more cooperating locations (e.g., parallel processing computer, computer network).

It is to be appreciated that various aspects of the present invention can employ technologies associated with facilitating unconstrained optimization and/or minimization of error costs. Thus, non-linear training systems/methodologies (e.g., back propagation, Bayesian, fuzzy sets, non-linear regression, or other neural networking paradigms including mixture of experts, cerebella model arithmetic computer (CMACS), radial basis functions, directed search networks and function link networks) can be employed.

The present invention can utilize web-based platforms, which typically include web servers, employment of hypertext transfer protocols (HTTP), and web browsers. A given computer can have at least one HTTP client, which forwards a user's request. Web servers are frequently part of larger integrated packages that contain programs related to Internet (and intranet) usage for serving email, publishing and/or designing web pages, and/or downloading requests for file transfer protocol (FTP) files.

A web server employs client/server models to deliver web pages and/or files to users via HTTP's. A client/server model describes a relationship wherein a client makes a service request from the server, which responds to and/or satisfies the request. Client/server models are especially practical in applications that facilitate connection of disparately located programs in a network. In a typical client/server model, a server is activated (often called a “daemon”) to await requests from clients. A single server can receive and fulfill requests from a vast plurality of clients. For example, a web browser is a client program that requests service from a web server, or HTTP server, in a disparately located computer on the Internet. According to another example, a client may make a request via a TCP/IP for files from an FTP server in another computer on the Internet.

HTTP refers to a protocol, or rule set, for file and/or data transfer over the Internet. More specifically, HTTP is a protocol that uses the TCP/IP family of protocols. Basically, HTTP embraces the concept that files contain references to other files, the selection of which will create additional transfer requests. Every web server has associated with it an HTTP daemon that waits for HTTP requests from a client, such as a web browser, and fulfills the requests as they are received. Upon entry of a uniform resource locator (URL) or a hyperlink into a browser, the browser builds an HTTP request and sends it to the Internet Protocol (IP) address contained in or referenced by the URL. Additionally, URLs can contain logical server names (e.g., “www.rockwellautomation.com”), which are translated into IP addresses by a Domain Name System (DNS) or other name resolution services (e.g., Windows Internet Naming Service (WINS)), instead of actual IP addresses. At the web server, the HTTP daemon receives the request and responds by sending the requested file(s) and/or data. The present invention can employ such client/server models to facilitate rendering web-based HMI(s) via HTTP(s).

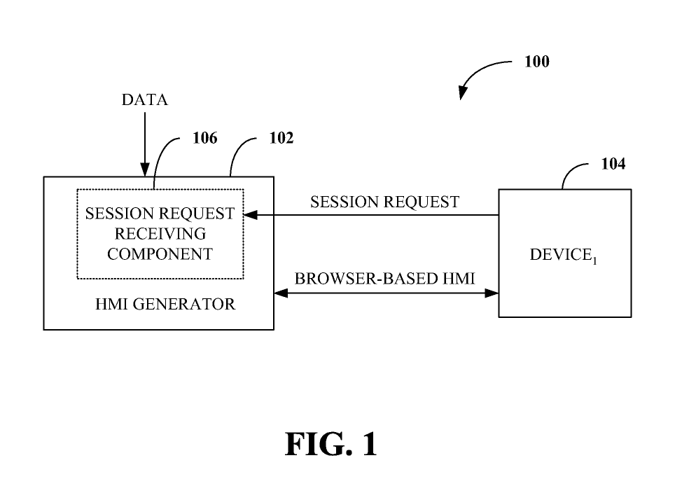

FIG. 1 is an illustration of a system 100 according to an aspect of the present invention, in which a HMI generator 102 is operably coupled to a device 104. The HMI generator 102 is capable of receiving and processing incoming data. The device 104 can submit a session request (utilizing, for example, HTTP, TCP/IP, etc.) to a session request-receiving component 106 associated with the HMI generator 102 to initiate communication between the device 104 and the HMI generator 102. The HMI generator 102 can communicate bi-directionally with the device 104 via a web browser on, for example, the Internet, to render a HMI via the browser to the device 104.

The device 104 can be, for example, a personal computer, a PDA, a web phone, an industrial computer, or any other suitable means capable of displaying the HMI 106. It is to be understood that discussion herein pertaining to a “device” is intended to encompass a device capable of rendering a HMI. Additionally, a “HMI” itself can be a “device”. Therefore, the terms “device” and/or “HMI” can be mutually inclusive and/or interchangeable as described herein.

According to one aspect of the present invention, the device 104 can be, for example, a fixed HMI, such as a graphical interface on a stationary monitor used in conjunction with a personal and/or industrial computer. According to another example, the device 104 can be a tethered portable HMI, such as the Machine Terminal MT750 or the Guard Terminal G750, both manufactured by Allen-Bradley. A tethered portable HMI offers several advantages over the fixed HMI; the most important being increased mobility to manually inspect the plant floor with the HMI in hand, thus permitting increased productivity. For example, an operator using a tethered portable HMI can respond to alarms and/or adjust machine settings with the HMI in hand. Increased mobility further enables greater troubleshooting capability and reduced set up time.

According to yet another example, the device 104 can be a wireless HMI, wherein the term “wireless HMI” is meant to encompass any mobile computing device utilized in connection with wireless network communication (e.g., laptops, tablets, PDAs, . . . ). A wireless HMI offers even greater mobility than the tethered portable wireless, and its range can be extended by distributing additional base stations throughout a large plant. In this manner, an operator can access information regarding a given machine and control the machine from any point in the plant. Furthermore, several wireless computing devices operate on a thin client platform, which permits facilitated integration to new or extant control architectures. By utilizing this technology, the wireless computing device can act as a thin client to computer applications. Because communication with the server can occur via a network link, this aspect of the present invention advantageously reduces hardware and software costs.

The system 100 can also comprise, for example, a web server (not shown) designated for receiving requests from client devices and/or web browsers. Such a web server can employ an HTTP daemon as described above, to facilitate responding to client requests. In this manner, HMIs can be rendered and delivered to client devices and/or browsers for rendering on the device 104.

Yet another aspect of the invention provides for transmitting significant amounts of data from a web server (not shown) to a client device 104 in a continuous, asynchronous fashion. Furthermore, the present invention can send “unsolicited” data from servers to specific clients. Such aspects advantageously solve problems in the current state of Web technology, which is client-driven and synchronous in nature, typically utilizing “request-response protocols”. Currently, each interaction between a client and a server consists of a client request and a server response (e.g., data is requested by a client, a server acknowledges that the requested operation has been performed, indicates an error condition, etc.). The client, after sending the request, must await the server's response before proceeding with other operations. Furthermore, once an individual request-response transaction has been completed, the connection between the client and server is severed, and a new connection must be established for each new transaction. The present invention can utilize continuous streams of data that can be transmitted between servers and clients, and, furthermore, can employ asynchronous and/or server initiated transactions in addition to client initiated transactions in order to provide solutions to the short-comings of current web-based technologies.

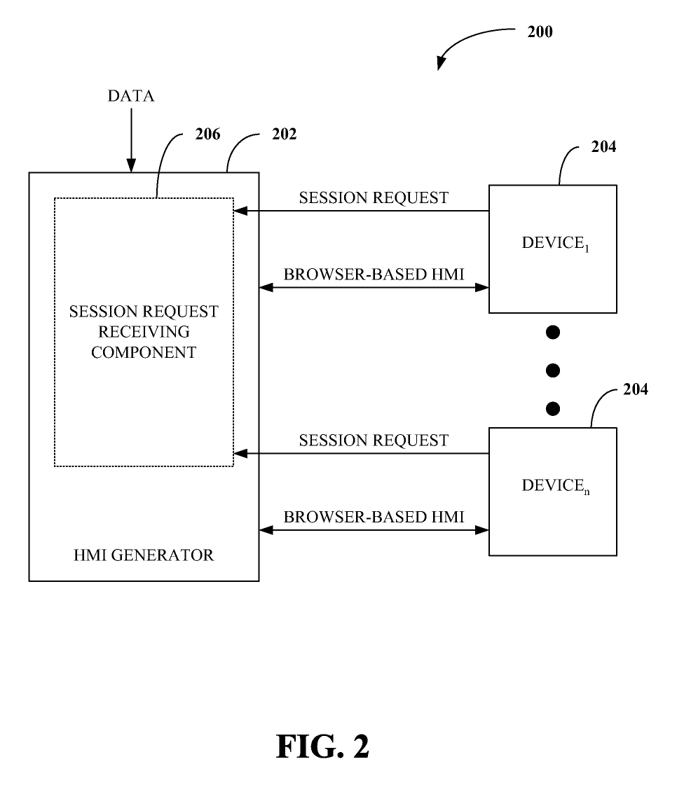

FIG. 2 is an illustration of a system 200 according to an aspect of the invention wherein a HMI generator 202 is operably coupled to a plurality of devices 204₁₋ₙ. According to one example, the devices 204₁₋ₙ request a browser session via a session request-receiving component 206. The HMI generator 202 can render a HMI via a web browser to devices 204₁₋ₙ. The devices 204₁₋ₙ can be disparately located (e.g. in different rooms, buildings, cities, states, countries, etc.). This aspect of the invention advantageously permits a plurality of users to simultaneously view a HMI. Additionally, the HMI generator 202 can permit a plurality of users to view multiple different HMIs simultaneously and in different geographical locations. To further this example, a plurality of HMIs can be rendered to a single device. The different HMIs can be related to a single industrial environment or can be unrelated. The device 204ₙ is illustrated to show an important aspect the invention wherein the HMI generator 202 can communicate via plurality of web browsers to a plurality of devices. This aspect permits the system 200 to render m number of HMIs to n number of devices in potentially disparate locations.

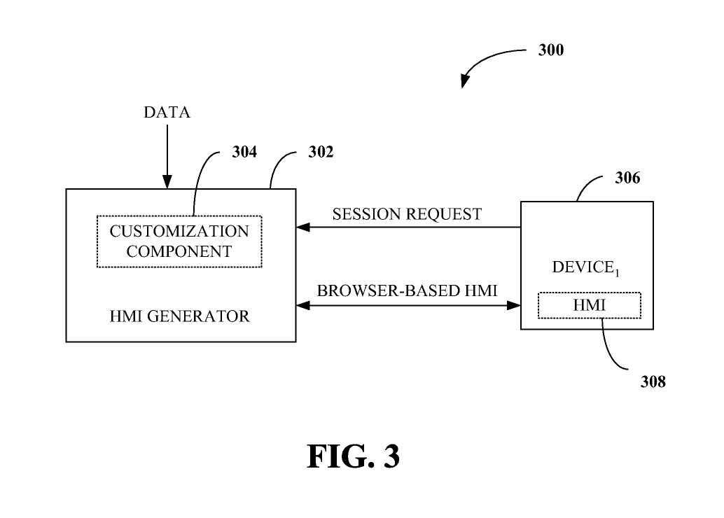

FIG. 3 is an illustration of a system 300 according to an aspect of the invention. A HMI generator 302 is associated with a customization component 304. The HMI generator 302 is operably coupled to a device 306 via a web browser. The device 306 is capable of rendering a HMI 308. A user of the device 306 can employ the customization component 304 to select unique HMI attributes desired by the user. For example, custom options can include, but are not limited to, a particular language in which a HMI is to be rendered, the type of industrial equipment to be included in a HMI, the type of information in which the user is interested, etc. This list of custom options is given for exemplary purposes only and is in no way intended to limit the scope of the present invention.

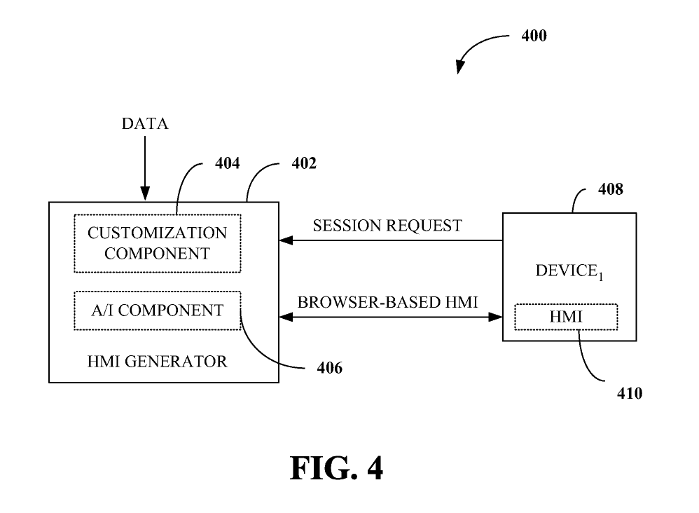

FIG. 4 is an illustration of a system 400 in accordance with an aspect of the claimed invention. The system 400 can employ various inference schemes and/or techniques in connection with rendering data at high resolution. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention.

Still referring to FIG. 4, the system 400 comprises a HMI generator 402 associated with a customization component 404 and an artificial intelligence (A/I) component 406. The HMI generator 402 and associated components are operably coupled to a device 408 via a browser. The device 408 is further associated with a HMI 410. The A/I component 406 is capable of making inferences regarding, for example, a most suitable format for generating the HMI 410 that is to be rendered to a user via the device 408. For instance, the A/I component 406 can infer the graphical rendering capabilities of a device requesting a session in order to determine a most suitable resolution for rendering a HMI to the device (e.g., a high-resolution monitor has much higher rendering capabilities than a visual display on a web-phone).

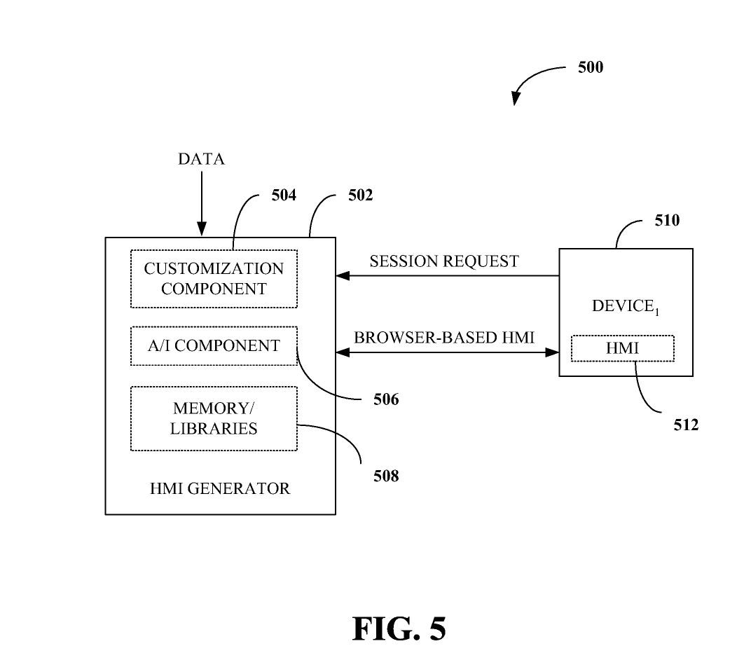

FIG. 5 is an illustration of a system 500 according to an aspect of the present invention. A HMI generator 502 is associated with a customization component 504 and an A/I component 506. The HMI generator is further associated with a memory 508. A device 510 capable of rendering a HMI 512 is operably coupled to the HMI generator 502 via a web browser. The memory 508 can comprise libraries associated with, for example, user history, user preferences, equipment lists, equipment functions, stored HMIs etc. The libraries can be employed by a user in conjunction with the customization component 504 and/or the A/I component 506 to enable a user to create a custom HMI. For example, a HMI rendered for a particular user in the past can be stored in a library in the memory 508 and later presented to that user when the user requests another session. Additionally, once a user has accessed a previously stored HMI, the user can initiate and/or continue customization of the selected HMI. This aspect of the invention advantageously stores generated HMIs at the location of the HMI generator so that a user need not dedicate valuable memory associated with the device 510 to store a generated HMI. However, it is to be appreciated that a generated HMI can be stored in the device if the user so desires, or in both the device 510 and the memory 508 of the HMI generator 502.

According to another aspect of the invention, a user can access a library associated with the memory 508 to view a list of industrial equipment that can be graphically represented by the HMI generator 502. A user can, for example, “click-and-drag” an icon representing an industrial pump onto an area designated for “selected equipment”. The HMI generator 502 can employ the A/I component 506 to infer that the user desires information associated with that pump and or a plurality of pumps. According to this example, the HMI 512 can include a rendering of an icon representing a pump and information associated therewith, such as flow-rate, valve pressure, etc.

It is to be appreciated that the memory 508 associated with the HMI generator 502 of the present invention can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 508 of the present systems and methods is intended to comprise, without being limited to, these and any other suitable types of memory.

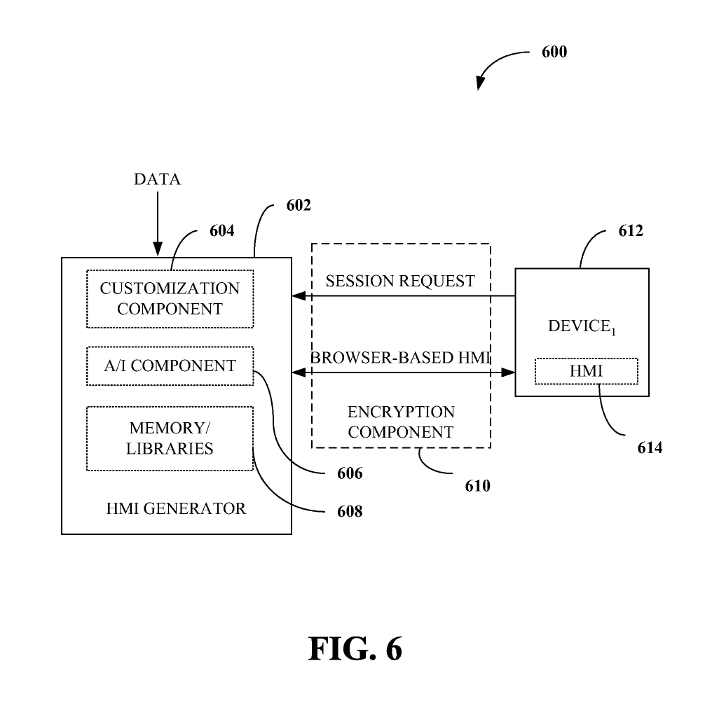

FIG. 6 is an illustration of a system 600 according to an aspect of the present invention. A HMI generator 602 is associated with a customization component 604, an A/I component 606, and a memory 608. The HMI generator is further associated with an encryption component 610. A device 612 capable of rendering a HMI 614 is operably coupled to the HMI generator 602 via a web browser. The encryption component 610 can ensure that information that a user wishes to keep confidential cannot be deciphered by unintended recipients.

Additionally, the HMI generator 602 can include an authentication component (not shown) to ensure that transmitted information is from a trusted source. The present invention can employ varied means to effectuate authentication of information, including but not limited to: password authentication protocol (PAP; e.g., username and password are required to access the system, wherein failure of the username and/or password to precisely match results in denial of access, etc.); digital signature; pass-card requirement (e.g., a card with a magnetic strip having information related to the user's identity, a “smart” card with an chip containing user-identity information embedded in it, etc.); biometric identification (e.g., fingerprint scan, retina scan, voice identification, etc.); challenge-response systems (e.g. challenge handshake authentication protocol (CHAP), etc.); or any other suitable means of authenticating that information transmitted between the HMI generator 602 and the device 612 is from a trusted source.

Furthermore, the authentication component can employ various methods to ensure that the integrity of the data being transmitted has not been compromised. For example, a checksum can be employed to verify that the data is intact by determining the modulo²⁵⁶ of the sum of the byte-values in the data packet. (256 is used as the divisor because a single byte can have a maximum value of 256, if the first bit is assigned the value of 2⁰.) Additionally, the authentication component can employ a cyclic redundancy check (CRC) to verify the integrity of the transmission. CRCs are more accurate than checksums and employ polynomial division to determine a value for the CRC. The authentication component can further employ cryptographic functions, such as digitally signed one-way hashes and/or message digests, which are highly resistant to tampering and, thus, are more efficient than both checksums and CRCs at ensuring data integrity.

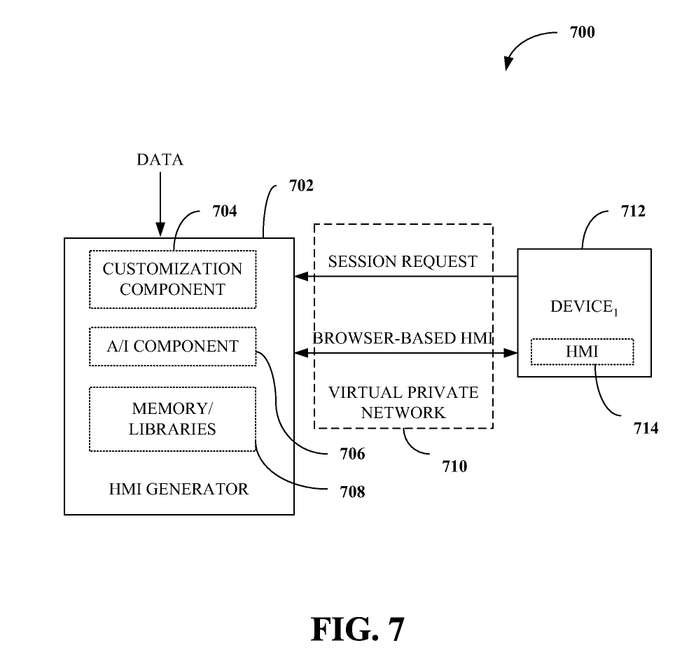

FIG. 7 is an illustration of a system 700 in accordance with an aspect of the present invention. A HMI generator 702 is associated with a customization component 704, an A/I component 706, and a memory 708. The HMI generator is further associated with Virtual Private Network (VPN) 710. A device 712 capable of rendering a HMI 714 is operably coupled to the HMI generator 702 via a web browser.

A VPN is a secure private network that links remote sites and/or users via a public network (e.g., the Internet). VPNs mitigate costs associated with conventional dedicated connections, such as leased lines via employing “virtual” connections between users via the Internet. Two extant types of VPN are remote-access and site-to-site. Remote-access VPNs are also called virtual private dial-up networks (VPDNs), and employ a local area network (LAN) to create connections between users. A site-to-site VPN employs dedicated equipment and complex encryption to connect multiple sites over a public network (e.g., the Internet). A site-to-site VPN can be Intranet- and/or Extranet-based. Intranet-based, site-to-site VPNs can be useful when a client desires one or more remotely located users to have access to a single private network: these connections are typically made LAN-to-LAN. Extranet-based, site-to-site VPNs are typically employed when two or more relatively large groups of users need to share a network and also employ LAN-to-LAN connections. For example, an automated manufacturing company might desire to share its network with its major supplier, such that the supplier can access the manufacturer's inventory data and adjust a shipment schedule accordingly.

Advantages associated with employing a VPN can include, for example, reduced operating costs, increased productivity, increased networking capability and opportunity, increased security, scalability, and reliability, etc. Security can be augmented by employing firewalls, which protect a private network from potential intruders who might attempt to gain access via the Internet. For example, if a packet of unauthorized information is encountered by a firewall, built-in filters can flag the packet so that it is denied access to the private network.

Encryption can further increase security with regard to private networks and can be implemented in several forms. The following discussion pertaining to encryption techniques is exemplary in nature, and is in no way intended to limit the scope of the claimed invention. According to one example, the present invention can employ symmetric-key encryption. This type of encryption associates each device coupled to the network with a unique “key” (e.g., a code) that can be used to encrypt a transmission before sending it to another device via the network. Every device in the transmission chain (e.g., sender and recipient(s)) must know the unique code in order to encrypt and decipher the transmission.

According to another example, the present invention contemplates employing public-key encryption, which utilizes both a private key and a public key. Each device has a private key (e.g., secret code) stored thereon. However, a public key is given to the recipient device by the sending device. The recipient device can only decode a transmission via employing both the provided public key and its own private key.

The present invention further contemplates the utilization of security features and/or systems such as, for example, Internet Protocol Security (IPSec), point-to-point tunneling protocol (PPTP), layer-2 forwarding (L2F), layer-2 tunneling protocol (L2TP) or any other suitable means for establishing a VPN via, for example, the Internet.

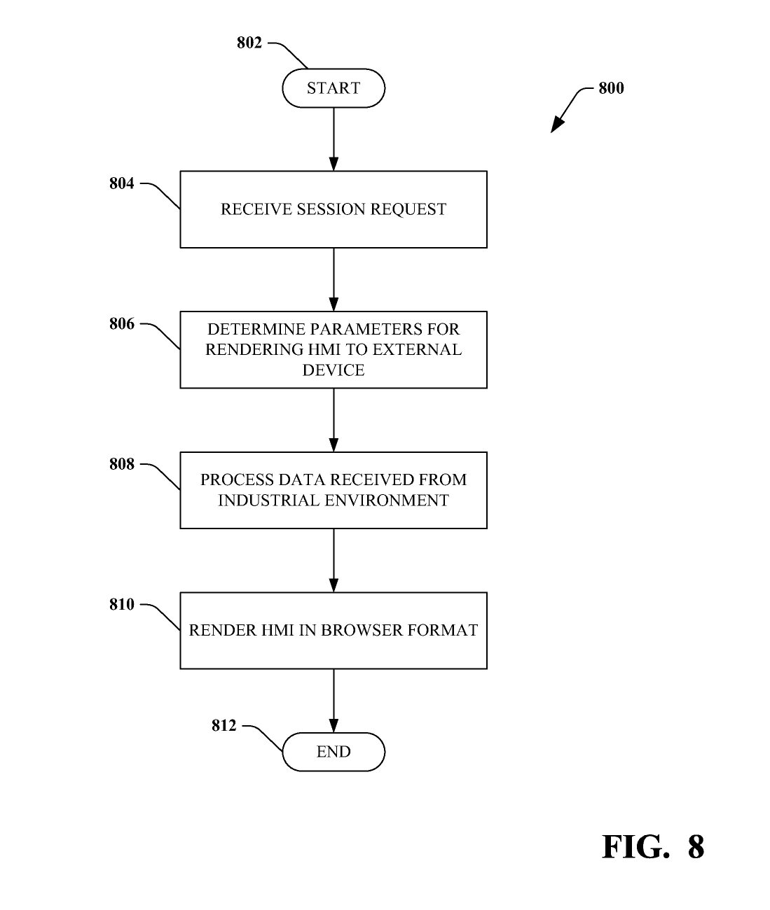

Turning briefly to FIGS. 8, 9, 10, and 11, methodologies that can be implemented in accordance with the present invention are illustrated. While, for purposes of simplicity of explanation, the methodologies are shown and described as a series of blocks, it is to be understood and appreciated that the present invention is not limited by the order of the blocks, as some blocks can, in accordance with the present invention, occur in different orders and/or concurrently with other blocks from that shown and described herein. Moreover, not all illustrated blocks may be required to implement the methodologies in accordance with the present invention.

Turning now to FIG. 8, a methodology 800 facilitating generating a HMI in browser format is illustrated. The methodology initiates at 802, and thereafter at 804 one or more session requests are received. In accordance with one aspect of the present invention, a HMI generator that facilitates generating HMI(s) in browser format can receive the session requests. Furthermore, the session requests can be initiated by a device desirably obtaining a HMI in browser format (e.g., HTML, XML, Java, etc.). The device can be any electronic device capable of storing, relaying, and/or displaying such HMI. For instance, a hard drive, a computer monitor, and/or a server are contemplated by the present invention as devices that can desirably obtain a HMI in browser format. The session requests can be user initiated and/or periodically initiated upon passage of a threshold amount of time. In accordance with another aspect of the present invention, artificial intelligence techniques can be utilized in conjunction with receiving the session requests. For example, a classifier can be employed to initiate a session request based upon user state and context, as well as other extrinsic data (e.g., available data regarding an industrial environment).

At 806, parameters relating to devices desirably obtaining a HMI in browser format are determined, wherein the parameters are utilized to render an optimal HMI. For example, disparate browser types and/or contexts can require different code language, formatting, etc. to enable optimal display and/or storage of a browser and browser contents. A browser associated with a PDA can require disparate formatting compared to a conventional browser associated with a desktop PC (e.g., Internet Explorer®, Netscape®, etc.). Furthermore, screen type, size, and/or resolution of particular device(s) can be considered prior to generating a HMI in browser format and relaying the HMI to the device(s). For example, a HMI rendered on a stand alone PC will be presented in a highly rich format, while the same HMI presented on a PDA (having limited screen real estate as well as processing capabilities) is displayed in a different format with an emphasis on presenting the data in a most meaningful manner to an end-user. In accordance with another aspect of the present invention, available memory of a hard drive desirably obtaining a HMI in browser format can be determined, thereby enabling an appropriately sized HMI to be rendered.

At 808, process data is received from an industrial environment, which can include a plurality of systems and/or processes. Furthermore, the systems and/or processes can be associated with a variety of individual components and/or actions. In accordance with one aspect of the present invention, sensing mechanisms can detect information at a variety of inputs and outputs of components and/or actions, and deliver the information to a HMI generator facilitating creation of a HMI in browser format. Alternatively, a user can enter information required for optimally generating the HMI in browser format. In accordance with another aspect of the present invention, artificial intelligence techniques can be utilized to generate data, thereby enabling rendering of a HMI in browser format that represents an industrial system and/or process at a future state. For example, a classifier can utilize user state and context, as well as historical usage of the system and/or process to infer a future state of the system and/or process, as well as generate data required for generating a HMI based on such inferred future state. Furthermore, the data can be continuously received regarding the industrial environment, thereby enabling real-time rendering of a HMI in browser format. This aspect of the invention provides a standard mechanism for dynamically updating browser displays in response to continually changing real-time data sent by a server.

At 810, the data obtained at 808 is utilized to render a HMI in browser format to particular device(s) on a network. For example, a high-resolution display device associated with a large amount of memory can receive a detailed rendering of a HMI in browser format, while a PDA with low resolution and little memory can receive a less detailed rendering. Furthermore, a rendering of a HMI can be automatically updated upon a change of state of an industrial environment. The present invention also contemplates real-time rendering of HMI(s) in a browser format.

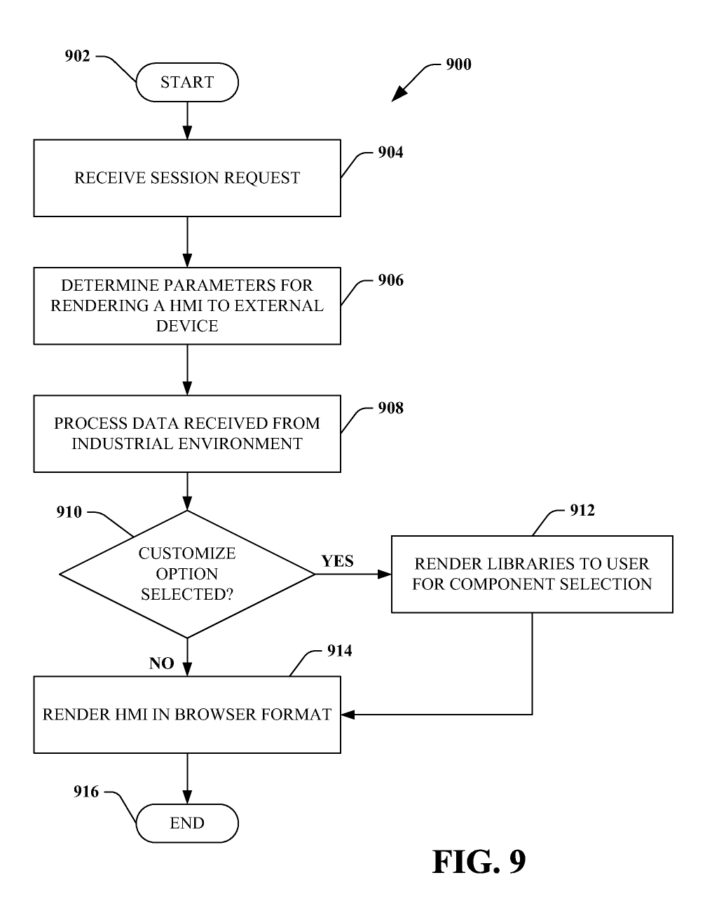

Turning now to FIG. 9, a methodology 900 facilitating custom rendering of HMI(s) in browser format is illustrated. The methodology 900 initiates at 902, and thereafter at 904 one or more session requests are received. The session requests inform a HMI generator that a rendering of a HMI in browser format is desirable, and can be delivered to the HMI generator via a user, automatically delivered periodically, initialized through artificial intelligence techniques, etc. At 906 parameters of device(s) desirably obtaining the HMI in browser format are determined, thus enabling optimal rendering of the HMI particular to the device(s). For example, a cellular phone that includes browser capabilities will desire a disparate rendering of a HMI when compared to the rendering desired by a desktop PC.

At 908, data received from an industrial environment is processed. The industrial environment can include a plurality of components associated with a plurality of systems, as well as various actions associated with an industrial process. Sensing mechanisms can be employed to monitor and/or relay information relating to the industrial environment to the HMI generator. At 910, a determination is made regarding whether a user desires to customize the HMI. If customization is desired, at 912 data libraries comprising various industrial environment entities (e.g., components, actions, systems, and/or processes) can be rendered to a user. One or more entities can be selected from the library, thereby enabling generation of a customizable HMI. At 914, the HMI is rendered in browser format. A customized HMI is rendered if the user desired creation of a custom HMI—otherwise a HMI in browser format is automatically rendered.

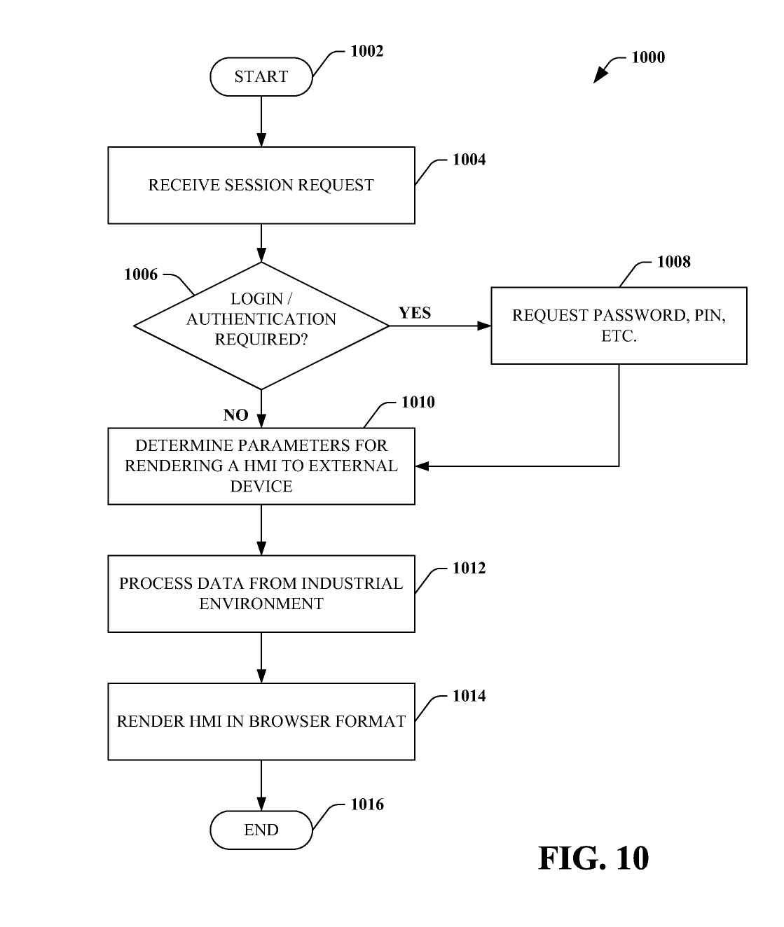

Now regarding FIG. 10, a methodology 1000 facilitating rendering a HMI in browser format upon security clearance is illustrated. The methodology 1000 begins at 1002, and at 1004 a HMI generator receives one or more session requests. In accordance with one aspect of the present invention, user(s) can initiate a session request that is delivered to the HMI generator. A determination is made at 1006 regarding whether login and/or authentication is required from user(s) and/or device(s) initializing the one or more session requests. If login and/or authentication is required, at 1008 authentication and/or identification of the user and/or device initializing the one or session requests is necessary to proceed with the methodology 1000. For example, a password, pin, or other suitable identification/authorization mechanisms can be requested from a user desiring rendering of a HMI in browser format. Data handshaking can also be required between device(s) and the HMI generator prior to rendering a HMI in browser format. Such security measures can be desirable to ensure freedom from tampering and/or factory secrecy (e.g., access to a HMI in browser format is desirably prohibited to competitors).

At 1010, parameters regarding device(s) requesting rendering of a HMI in browser format is determined, thereby facilitating an optimal rendering of the HMI for disparate device(s). At 1012, data received from an industrial environment (e.g., systems, process, components, actions, etc.) is received and processed to facilitate generating a correct HMI. Furthermore, artificial intelligence techniques can be utilized to render a HMI displaying a future state of an industrial environment. At 1014, the HMI is rendered in browser format and relayed to device(s) initializing the session request.

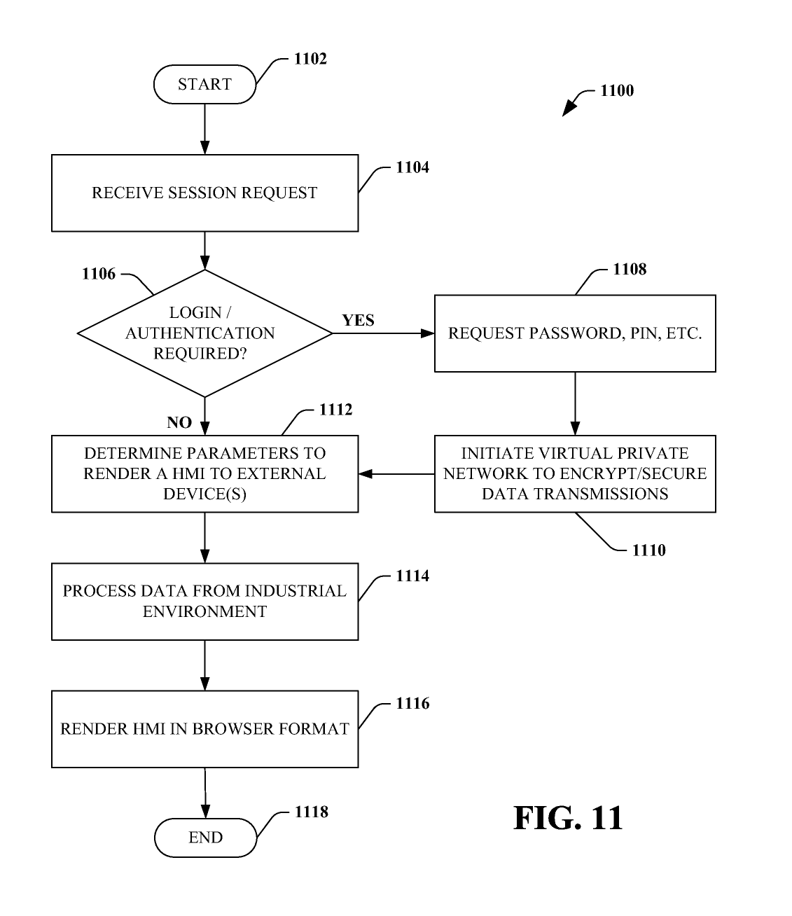

Now regarding FIG. 11, a methodology 1100 that facilitates securely relaying a HMI in browser format is illustrated. At 1102, the methodology 1100 is initiated, and at 1104 one or more session requests are received. At 1106, the methodology 1100 determines whether security measures are to be taken. Such determination can depend on user state and/or identity, location of a device(s) initiating the session request(s), etc. If security measures are to be taken, at 1108 a password, pin, or similar authenticating mechanism is requested, wherein user(s) and/or device(s) initiating the session request(s) will be denied access to a rendered HMI if the password and/or pin is not known. At 1110, a private network that can include various encryption techniques is initiated to facilitate secure data transaction between the HMI generator and the user(s) and/or device(s) initiating the session request(s) (e.g., a rendered HMI in browser format can be securely relayed from the HMI generator to the user(s) and/or device(s)). In accordance with one aspect of the present invention, a virtual private network (VPN) can be provided. The VPN can be a remote-access VPN (also known as a virtual private dial-up network) and/or a site-to-site VPN. The site-to-site VPN can be either intranet based (e.g., one or more remote locations desirably joined in a single private network) or extranet based (a private connection between two companies). Furthermore, firewalls and encryption, such as symmetric-key encryption and public-key encryption, can be employed in connection with the VPN. An Internet Protocol Security Protocol (IPSec) can also be provided for enhanced security features such as better encryption algorithms and more comprehensive authentication. Moreover, a secure server, such as an authentication, authorization and accounting (AAA) server, can be associated with the VPN in accordance with another aspect of the present invention.

At 1112 parameters of device(s) desirable receiving a rendering of a HMI in browser format are determined. For example, screen size and resolution of a display device can be determined, thereby enabling an optimal rendering of the HMI for the particular display device. At 1114 data received from an industrial environment is processed. Such data can relate to systems, processes, components, actions, or other suitable industrial entities. At 1116 a HMI is rendered in browser format, wherein an optimal rendering occurs for particular devices.

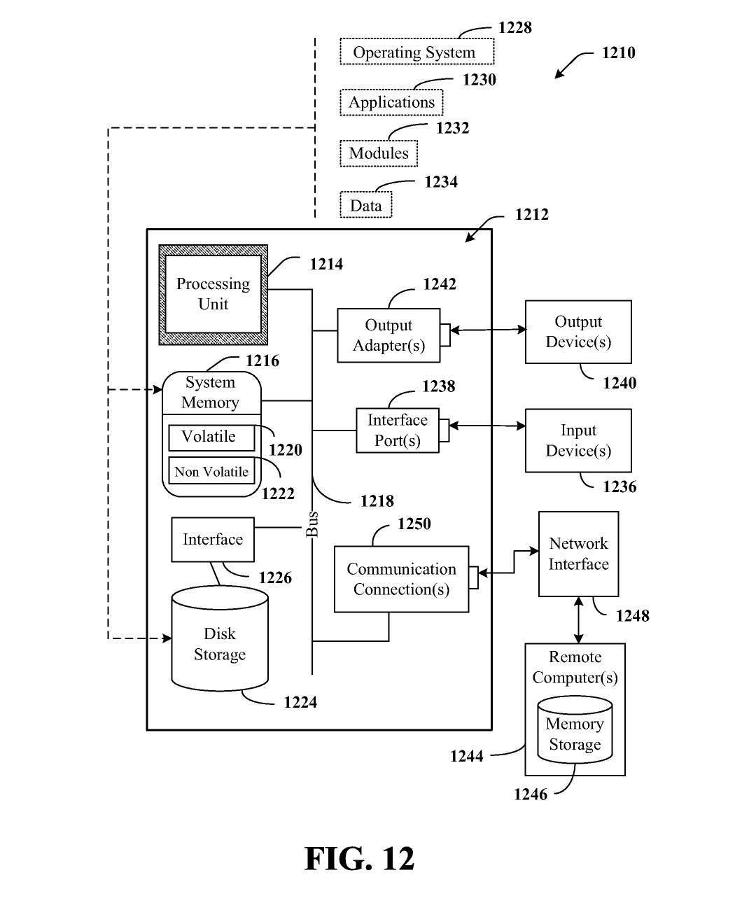

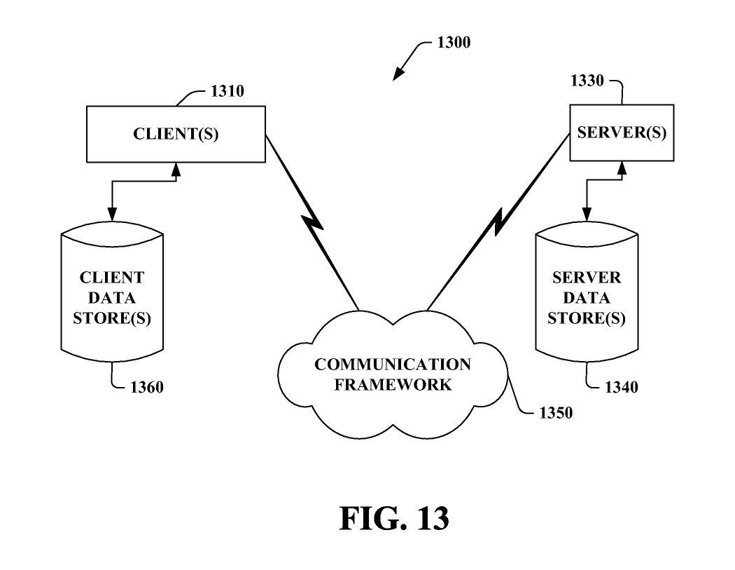

In order to provide a context for the various aspects of the invention, FIGS. 12 and 13 as well as the following discussion are intended to provide a brief, general description of a suitable computing environment in which the various aspects of the present invention can be implemented. While the invention has been described above in the general context of computer-executable instructions of a computer program that runs on a computer and/or computers, those skilled in the art will recognize that the invention also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention can also be practiced in distributed computing environments where task are performed by remote processing devices that are linked through a communications network. However, some, if not all aspects of the invention can be practiced on stand-alone computers. In a distributed computing environment, program modules can be located in both local and remote memory storage devices.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive), a digital versatile disk ROM drive (DVD-ROM), DVD recordable drive (DVD-R), DVD rewritable drive (DVD-RW), and any other suitable DVD drives. To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port can be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

FIG. 13 is a schematic block diagram of a sample-computing environment 1300 with which the present invention can interact. The system 1300 includes one or more client(s) 1310. The client(s) 1310 can be hardware and/or software (e.g., threads, processes, computing devices). The system 1300 also includes one or more server(s) 1330. The server(s) 1330 can also be hardware and/or software (e.g., threads, processes, computing devices). The servers 1330 can house threads to perform transformations by employing the present invention, for example. One possible communication between a client 1310 and a server 1330 can be in the form of a data packet adapted to be transmitted between two or more computer processes. The system 1300 includes a communication framework 1350 that can be employed to facilitate communications between the client(s) 1310 and the server(s) 1330. The client(s) 1310 are operably connected to one or more client data store(s) 1360 that can be employed to store information local to the client(s) 1310. Similarly, the server(s) 1330 are operably connected to one or more server data store(s) 1340 that can be employed to store information local to the servers 1330.

What has been described above includes examples of the present invention. It is, of course, not possible to describe every conceivable combination of components or methodologies for purposes of describing the present invention, but one of ordinary skill in the art can recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
storing three-dimensional representations of a plurality of objects within an industrial automation environment in memory of at least one computing device;
receiving a reference point related to a location in the industrial automation environment;
employing a processor to calculate a field of view based at least in part on the reference point and to render the three-dimensional representations filtered based at least in part on the field of view.

2. The method of claim 1, further comprising receiving instructions grouping the three-dimensional representations into at least two cells; and storing the at least two cells in the memory.

3. The method of claim 2, wherein the receiving instructions further comprises marking the at least two cells with meta-data specific to at least one attribute.

4. The method of claim 3, wherein the marking further comprises marking the at least two cells with meta-data specific to at least one of a role or a time.

5. The method of claim 2, wherein the employing further comprises employing the processor to render at least one cell based at least in part on field of view.

6. A device, comprising:
a memory configured to store at least two cells comprising three-dimensional representations of a plurality of objects within an industrial automation environment;
an interface component configured to receive a reference point related to a location in the industrial automation environment; and
a processor configured to calculate a field of view based at least in part on the reference point and to render at least one cell filtered based at least in part on the field of view.

7. The device of claim 6, wherein at least one of the plurality of objects comprises at least one machine.

8. The device of claim 6, wherein at least one of the plurality of objects comprises at least one industrial automation device.

9. The device of claim 6, wherein the at least two cells are associated with meta-data.

10. The device of clam 9, wherein the meta-data relates to at least one of a role or a time.

11. The device of claim 9, wherein the meta-data relates to at least one of an operational requirement of at least one of the plurality of objects or a configuration of at least one of the plurality of objects.

12. The device of claim 9, wherein the processor is further configured to render the at least one cell based at least in part upon the field of view and the meta-data.

13. The device of claim 6, wherein the interface component is further configured to transmit the rendering of the at least one cell to at least one remote device.

14. A computer, comprising:
a memory configured to store three-dimensional representations of a plurality of objects within an industrial automation environment;
an interface component configured to receive a reference point related to a location in the industrial automation environment; and
a processor configured to calculate a field of view based at least in part on the reference point and to render the three-dimensional representations filtered based at least in part on the field of view.

15. The computer of claim 14, wherein at least one of the plurality of objects comprises at least one machine.

16. The computer of claim 14, wherein at least one of the plurality of objects comprises at least one industrial automation device.

17. The computer of claim 14, wherein the interface component is further configured to receive instructions grouping the three-dimensional representations into at least two cells; and the memory is further configured to store the at least two cells.

18. The computer of claim 17, wherein the interface component is further configured to receive meta-data specific to the at least two cells and the memory component is further configured to store the meta-data specific to the at least two cells.

19. The computer of claim 18, wherein the processor is further configured to render at least one of the at least two cells based at least in part upon the field of view.

20. The computer of claim 19, wherein the processor is further configured to render the at least one of the at least two cells based at least in part upon the meta-data.
